(19) United States
(12) Patent Application Publication
(10) Pub. No.: US 2022/0315796 A1
(43) Pub. Date: Oct. 6, 2022

(54) SOUNDPROOF BODY PROVIDED WITH SOUND INSULATING LAYER FORMED OF URETHANE RESIN, AND MANUFACTURING METHOD OF SOUND INSULATING LAYER BY APPLICATION OF RAW MATERIAL FOR URETHANE RESIN

(71) Applicants: HOWA CO., LTD., Kasugai-shi, Aichi (JP); COVESTRO LLC, Pittsburgh, PA (US); COVESTRO DEUTSCHLAND AG, Leverkusen (DE)

(72) Inventors: Shinobu FUSHIKI, Kasugai-shi (JP); Takahiro ASAI, Kasugai-shi (JP); John W. JENNY, Pittsburgh, PA (US); Fumihiko NODA, Amagasaki (JP)

(73) Assignees: HOWA CO., LTD., Kasugai-shi, Aichi (JP); COVESTRO LLC, Pittsburgh, PA (US); CONVESTRO DEUTSCHLAND AG, Leverkusen (DE)

(21) Appl. No.: 17/299,942

(22) PCT Filed: Dec. 18, 2019
(86) PCT No.: PCT/US2019/067033

§ 371 Date: Jun. 4, 2021

(51) Int. Cl. C09D 175/04; C09D 5/00; B05B 7/04

(52) U.S. Cl. CPC C09D 175/04; C09D 5/00; B05B 7/04; C08K 2003/3045

(57) ABSTRACT

A manufacturing method of a sound insulating layer by application of raw materials for urethane resin, by applying row materials for urethane resin in their liquid states along a surface of a porous layer of a soundproof body to manufacture as the sound insulating layer.

### BACKGROUND OF THE INVENTION

### Field of the Invention

The present invention relates to a soundproof body provided with a sound insulating layer formed of urethane resin, and a manufacturing method of the sound insulating layer by application of raw materials for urethan resin.

### Description of the Related Art

Conventionally, as a sound insulating or shielding sheet common to sound insulating layers, a sound shielding sheet for motor vehicles described in the following Patent Literature 1 is proposed. The sound insulating sheet is produced by using resins, a high-specific gravity filler, and the like.

Specifically, the sound shielding sheet is produced by forming a molten compound into a sheet by a calendar roll method or a T-die extrusion method. In this production, the molten compound is formed by adding an anti-adhesive agent and a coloring agent to an olefin resin and a high-specific gravity filler, thereby to mix them uniformly. Here, in the calendar roll method, the molten compound is formed into a sheet by a calendar roll.

In the T-die extrusion method, the molten compound is formed into a sheet by an extrusion die, and produced as a sound shielding sheet.

### PRIOR ART LITERATURE

### Patent Literature

Patent Literature 1: JP H10-168255 A

### SUMMARY OF THE INVENTION

By the way, in case the sound shielding sheet produced in the manner as described above is used, for instance, in an interior space of a motor vehicle or the like, it is required to be as thin as possible and as heavy as possible as the sound shielding sheet, because the interior space is narrow and ensuring of good sound shielding property is desired.

However, if the sound shielding sheet is too thin, the sound shielding sheet cannot act as a sound shielding sheet, because it may be torn or broken in the course of being cooled through a roll.

In laminating the sound shielding sheet produced as described above on, for example, a sound absorbing layer such as a felt layer or the like, the sound shielding layer is laminated on the sound absorbing layer by manually bonding the sound shielding sheet to the sound absorbing layer. Therefore, the workability is very poor. Such a problem is more significant as the layer is thinner.

Moreover, production of the sound shielding sheet and lamination of the sound shielding sheet on the sound absorbing layer are performed in different processes since the sound shielding sheet is bonded to the sound absorbing sheet manually as described above. Thus, the working efficiency is very poor.

Therefore, in order to cope with the problems as described above, it is a primary object of the present invention to provide a soundproof body provided with a sound insulating layer formed of urethane resin, focusing on the usefulness of the urethane resin.

Also, in order to cope with the problems as described above, it is another object of the present invention to provide a manufacturing method of the sound insulating layer by application of raw materials for urethane resin, by applying raw materials for urethane resin in their liquid states along a surface of a porous layer of the soundproof body to manufacture as the sound insulating layer.

For solving the above-described problems, a soundproof body provided with a sound insulating layer comprising a porous layer, and a sound insulating layer laminated on the porous layer.

The sound insulating layer is formed with urethane resin so as to have a basis weight within a predetermined low basis weight range, the sound insulating layer being laminated on the porous layer.

According to the construction, the sound insulating layer is formed with urethane resin so as to have a basis weight within a predetermined low basis weight range and is laminated on the porous layer. Therefore, the soundproof body is capable of exerting an excellent sound insulating effect under sound insulating performance of the sound insulating layer against noises from the porous layer and can be provided as a very lightweight soundproof body.

Herein, since the predetermined low basis weight range is a range of 200 (g/m²) to 2000 (g/m²), the above-mentioned operation and effect of the present invention can be ensured more successfully.

Further, the above-described soundproof body may be a soundproof body for a motor vehicle attached to a body panel of the motor vehicle.

For solving the above-described problems, a manufacturing method of a sound insulating layer in a soundproof body by application of raw materials for urethane resin according to the present invention, which comprises:

an applying process of atomizing a mixed liquid formed by mixing polyol, isocyanate and filler as a mixed liquid for atomization along a surface of a porous layer of the soundproof body by a sprayer to apply the atomized mixed liquid in a layer-like fashion on the surface of the porous layer,

wherein at the application process, the mixed liquid for atomization is adhesively formed on the surface of the porous layer as a sound insulating layer of urethane resin in accordance with hardening of the mixed liquid for atomization caused by its applying.

According to such a construction, in manufacturing the sound insulating layer in the soundproof body, at the applying process, a mixed liquid formed by mixing polyol, isocyanate and filler is atomized and applied as a mixed liquid for atomization in a layer form by sprayer along a surface of a porous layer of the sound insulator.

Thereafter, the mixed liquid for atomization is adhesively formed and manufactured on a surface of the porous layer as a sound insulating layer formed of urethane resin in accordance with hardening of the mixed liquid for atomization caused by its applying.

As a result, it is possible to manufacture the sound insulating layer in such a manner that the sound shielding layer is adhesively formed on the surface of the porous layer without accompanied by troublesome steps of manually laminating the sound insulating layer on the sound absorbing layer.

Also, the mixed liquid for atomization is adhesively formed and manufactured on a surface of the porous layer as a sound insulating layer formed of a urethane resin in accordance with hardening of the mixed liquid for atomization caused by its applying, as previously described. Thus, manufacturing of the sound insulating layer of urethane resin based on polyol, isocyanate and filler and adhesion of the sound insulating layer to the surface of the porous layer can be achieved simultaneously. This leads to improvement in working efficiency without conducting manufacturing of the sound insulating layer and laminating of the sound insulating layer on the porous layer in separate steps.

Herein, application of the mixed liquid as the mixed liquid for atomization may be conducted so that a basis weight of the sound insulating layer becomes to a value within a predetermined low basis weight range.

According to this construction, the sound insulating layer is manufactured to have a basis weight within the predetermined low basis weight range. Therefore, the soundproof body having the sound insulating layer manufactured in this manner is capable of exerting excellent soundproof effect under sound insulating performance of the sound insulating layer against noises from the porous layer and can be manufactured as a very lightweight soundproof body.

Furthermore, a manufacturing method of a sound insulating layer in a soundproof body by application of raw materials for urethane resin, which comprises:

an applying process in which a first mixed liquid of polyol and filler and a second mixed liquid of isocyanate and filler, which are prepared separately as a raw material for urethane resin, are mixed as a mixed liquid for atomization and atomized by a sprayer along a surface of a porous layer of the soundproof body to apply the mixed liquid for atomization in a layer-like fashion along the surface of the porous layer.

At the applying process, the mixed liquid for atomization is adhesively formed on the surface of the porous layer as a sound insulating layer of urethane resin in accordance with hardening of the mixed liquid for atomization caused by its applying.

According to such a construction, in manufacturing of the sound insulating layer, the first mixed liquid formed of polyol and filler, and the second mixed liquid formed of isocyanate and filler are separately prepared as a material for urethane resin.

Then, at the applying process, the first and second mixed liquids are mixed and applied as a mixed liquid for atomization in a layer form by a sprayer along a surface of a porous layer, and the mixed liquid for atomization is adhesively formed and manufactured along the surface of a porous layer as a sound insulating layer formed of a urethane resin in accordance with hardening of the mixed liquid for atomization caused by its applying.

In this manner, by atomizing the separately prepared first mixed liquid and second mixed liquid under mixing as a mixed liquid for atomization along a surface of a porous layer, the mixed liquid for atomization is adhesively formed and manufactured on a surface of the porous layer as a sound insulating layer formed of a urethane resin in accordance with hardening of the mixed liquid for atomization caused by its applying. Therefore, it is possible to manufacture the sound insulating layer so as to adhere the sound insulating layer on the surface of the porous layer without troublesome steps of manually laminating the sound insulating layer on the sound absorbing layer. This can be established even when the sound insulating layer is thin because the sound insulating layer is manufactured in a layer form by application with mixed atomization of the first mixed liquid and the second mixed liquid.

Further, the sound insulating layer formed of urethane resin is adhesively formed on a porous member by application with mixed atomization of the first mixed liquid and the second mixed liquid, as described above. Thus, formation of the sound insulating layer of urethane resin based on the first mixed liquid and the second mixed liquid, and adhesion of the sound insulating layer to the surface of the porous member can be achieved simultaneously. This leads to improvement in working efficiency without conducting formation of the sound insulating layer and lamination of the sound insulating layer on the porous member in separate steps.

Herein, application of the first and second mixed liquids as the mixed liquid for atomization may be performed so that a basis weight of the sound insulating layer becomes a value within a predetermined low basis weight range.

According to this construction, the sound insulating layer is manufactured so as to have a basis weight within a predetermined low basis weight range. Therefore, the soundproof body having the sound insulating layer manufactured in this way is capable of exerting an excellent sound insulating effect under sound insulating performance of the sound insulating layer against noises from a porous layer and can be provided as a very lightweight soundproof body.

In the present invention,

a first mixing process of mixing powdery filler into liquid polyol to form the first mixed liquid,

a second mixing process of mixing powdery filler into liquid isocyanate to form the second mixed liquid,

a first pressure elevating process of elevating pressure of the first mixed liquid formed at the first mixing process to forming a first high-pressure mixed liquid, and

a second pressure elevating process of elevating pressure of the second mixed liquid to form a second high-pressure mixed liquid.

At the applying process, the first high-pressure mixed liquid formed at the first pressure elevating process and the second high-pressure mixed liquid formed at the second pressure elevating process are mixed as the mixed liquid for atomization and atomized by the sprayer along the surface of the porous layer of the soundproof body to apply the mixed liquid for atomization along the surface of the porous layer in a layer-like fashion, the mixed liquid for atomization being adhesively formed on the surface of the porous layer as a sound insulating layer of urethane resin in accordance with hardening of the mixed liquid for atomization caused by its applying.

According to the above-described construction, operations and effects similar to those of the present invention described above can be achieved by the following procedures.

In the procedures, the first mixed liquid is formed by mixing liquid polyol and powdery filler in the first mixing process and the second mixed liquid is formed by mixing liquid isocyanate and powdery filler in the second mixing process without preparing previously the first mixed liquid and the second mixed liquid as raw materials for urethane resin.

Then, the first mixed liquid is formed as the first high-pressure mixed liquid in the first pressure elevating process, and the second mixed liquid is formed as the second high-pressure mixed liquid in the second pressure elevating process.

Subsequently, at the applying process, the first high-pressure mixed liquid formed in the first pressure elevating process and the second high-pressure mixed liquid formed in the second pressure elevating process are mixed and atomized as the mixed liquid for atomization in a layer-like fashion by the sprayer along the surface of the porous member.

Even if the mixed liquid for atomization is adhesively formed on the surface of the porous member as the sound insulating layer formed of urethane resin in accordance with hardening of the mixed liquid for atomization caused by its applying, operations and effects similar to those of the present invention described above can be achieved.

Herein, application of the first high-pressure mixed liquid and the second high-pressure mixed liquid as the mixed liquid for atomization may be performed so that a basis weight of the sound insulating layer becomes a value within the above-described predetermined low basis weight range.

According to this construction, the sound insulating layer is manufacture to have a basis weight within the predetermined low basis weight range. Therefore, the soundproof body having the sound insulating layer manufactured in this manner is capable of exerting excellent sound insulating effects under the sound insulating performance of the sound insulating layer against noises from the porous layer and can be manufactured as a very lightweight soundproof body.

The above-described predetermined low basis weight range may be within a range of 200 (g/m²) to 2000 (g/m²). According to this construction, the operation and effect of the present invention as described above can be ensured more successfully.

Also in the above-described present invention, a mixing amount of the filler in the first mixed liquid is a value within a range of 10 (wt %) to 70 (wt %), and a mixing amount of the filler in the second mixed liquid is a value within a range of 10 (wt %) to 70 (wt %), and

a volume ratio of the first mixed liquid to the second mixed liquid is a value within a predetermined volume ratio range of 2 to 5.

According to this construction, the mixture liquid of the first mixed liquid and the second mixed liquid is hardened and becomes proper urethane resin under curing action of isocyanate as a curing agent, thereby to be adhesively formed on a surface of the porous member as the sound insulating layer formed of urethane resin. As a result, the operation and effect of the present invention can be achieved more successfully.

### BRIEF DESCRIPTIN OF THE DRAWINGS

FIG. 1 is a diagrammatic partial schematic sectional view of an motor vehicle having a dash silencer to which one embodiment of the present invention is applied.

FIG. 2 is an enlarged front view of the dash silencer in FIG. 1.

FIG. 3 is a longitudinal sectional view of the dash silencer along the line 3-3 in FIG. 2.

FIG. 4 is a block diagram showing a construction of applying a raw material for urethane in a liquid state to a porous member in the above embodiment.

FIG. 5 is a partially broken sectional view schematically showing a sprayer of FIG. 4 viewed from a lateral face thereof.

FIG. 6 is a partially broken sectional view schematically showing the sprayer of FIG. 4 viewed from a top face thereof.

FIG. 7 is a sectional view schematically showing the sprayer of FIG. 5 viewed along the line 7-7.

FIG. 8 is a process chart showing a process of applying a raw material for urethane in a liquid state to a porous member in the above embodiment.

### DETAILED DESCRIPTION OF THE PREFERRED EMBODIMENT

Hereinafter, an embodiment of the present invention will be described with reference to drawings.

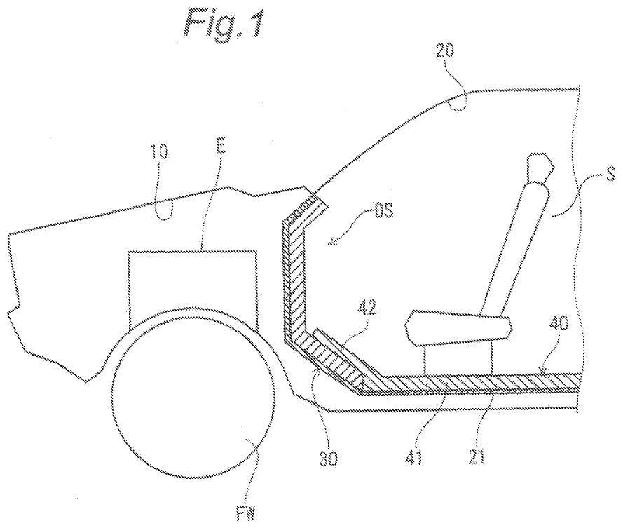

FIG. 1 shows a motor vehicle equipped with a dash silencer (hereinafter referred to as a dash silencer DS) to which an embodiment of the present invention is applied. The motor vehicle has an engine room 10 and a vehicle compartment 20, and the vehicle compartment 20 is provided to follow the engine room 10 in the motor vehicle.

As shown in FIG. 1, an engine E is disposed in the engine room 10, and the engine E is disposed on a bottom wall (not shown) of the engine room 10 between left and right front wheels FW (only left front wheel FW is shown in FIG. 1) of the motor vehicle. In addition, within the vehicle compartment 20, a front seat S is disposed on a floor wall 21 of the vehicle compartment 20 through a floor carpet 40 (described later).

Also, the motor vehicle is provided with a dash panel 30 (also referred to as dashboard 30), and the dash panel 30 is formed to have a longitudinal section curved shape shown in FIG. 1. The dash panel 30 constructed in such a way is, as shown in FIG. 1, disposed at the boundary between the engine room 10 and the vehicle compartment 20 to partition mutually the engine room 10 and the vehicle compartment 20.

The floor carpet 40 is formed by a carpet main body portion 41 and a front carpet portion 42, and the carpet main body portion 41 is laid along the floor wall 21 in a fore-and-aft direction thereof between the front seat S situated inside the vehicle compartment 20 and the floor wall 21. The front carpet portion 42 is laminated on a lower portion of the dash silencer DS by extending frontward along the lower portion of the dash silencer DS from an upper portion of a front end portion of the carpet main body portion 41. In addition, the carpet main body portion 41 abuts at a lower portion of its front end portion on a lower end portion of the dash silencer DS.

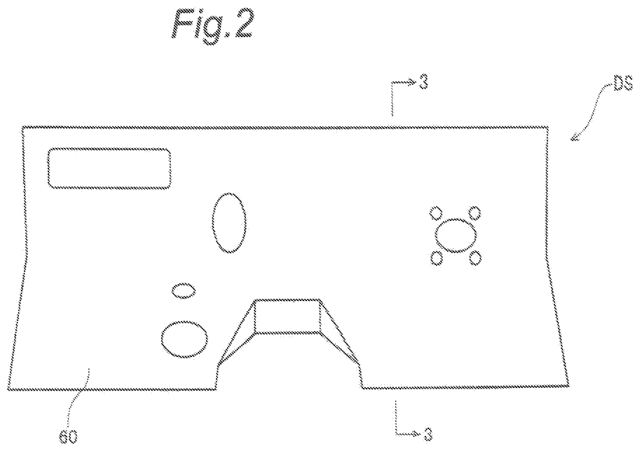

The dash silencer DS acts a role as a soundproof body. The dash silencer DS is attached from the side of the vehicle compartment 20 along the dash panel 30 at the same longitudinal section curved shape as the dash panel. Additionally, in the present embodiment, the outer shape of the dash silencer DS is almost the same as the outer shape of the dash panel 30 (see FIG. 2).

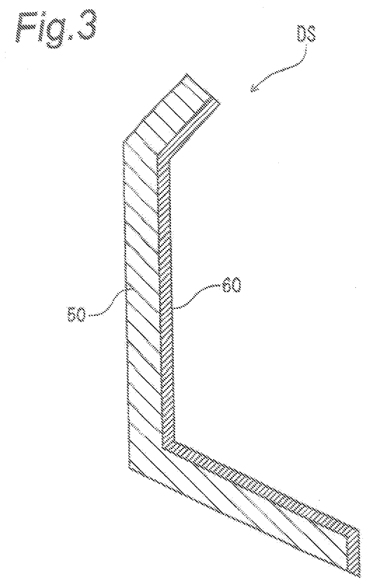

The dash silencer DS includes a sound absorbing layer 50 and a sound insulating or shielding layer 60, as shown in FIG. 3. The sound absorbing layer 50 is attached to the vehicle compartment 20 along the dash panel 30 from inside of the vehicle compartment 20, and the sound absorbing layer 50 is sometimes formed of felt. In addition, the sound absorbing layer 50 may be formed of any porous material without limited to felt, and accordingly the sound absorbing layer 50 can be said to be a porous layer.

The sound insulating layer 60 is laminated along the sound absorbing layer 50 with a basis weight within a predetermined low basis weight range by means of a urethane resin as described later so that it opposes the dash panel 30 through the sound absorbing layer 50. In addition, the basis weight within the predetermined low basis weight range varies within the predetermined low basis weight range depending on the thickness distribution of the sound insulating layer 60. In the present embodiment, the above-described predetermined low basis weight range is set to be the range of 200 (g/m²) to 2000 (g/m²). As a result, the sound insulating layer 60 is lighter than a conventional one and can exert excellent sound insulating performance.

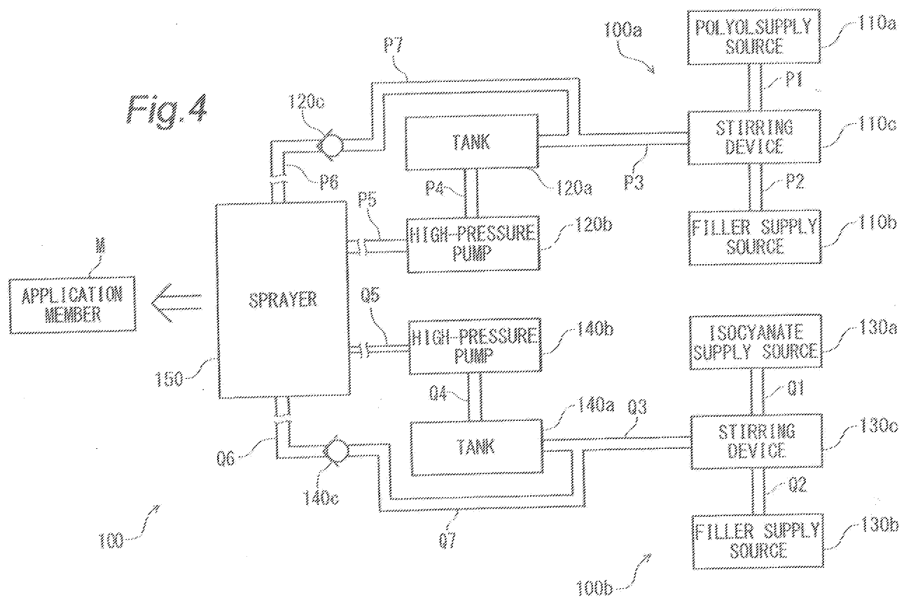

Next, an applying system 100 showing a construction required for applying a material for urethane resin to an application member M is described on a basis of FIG. 4. In the present embodiment, the application member M means the sound absorbing layer 50 of the dash silencer DS. In addition, as the applying system 100, for example, an HFR measuring system available from Graco Inc. can be mentioned.

The applying system 100 includes a polyol system portion 100a and an isocyanate system portion 100b. The polyol system portion 100a has a polyol supply source 110a, a filler supply source 110b and a stirring device 110c.

The polyol supply source 110a stores liquid polyol, and the polyol supply source 110a is capable of supplying the stirring device 110c with the liquid polyol. Herein, a supply amount of the liquid polyol to the stirring device 100c can be adjusted in the polyol supply source 110a. In addition, adjustment of the supply amount of the polyol in the polyol supply source 110a is conducted, for example, with a mechanism (for example, opening adjusting valve) for adjusting the opening of the supply port portion (not shown) to the stirring device 100c of the polyol supply source 110a.

The filler supply source 110b stores powdery barium sulfate or calcium carbonate, and the filler supply source 110b is capable of supplying the stirring device 100c with powdery barium sulfate. Herein, a supply amount of the powdery barium sulfate to the stirring device 100c can be adjusted in the filler supply source 110b. Additionally, adjustment of the supply amount of the barium sulfate in the filler supply source 110b is conducted, for example, with a mechanism (for example, opening adjusting valve) for adjusting the opening of the supply port portion (not shown) to the stirring device 110c of the filler supply source 110b.

The stirring device 110c stirs both of the liquid polyol supplied from the polyol supply source 110a through its supply port portion and piping P1 and the powdery barium sulfate supplied from the filler supply source 110b through its supply port portion and piping P2 according to its operation to mix them mutually and uniformly and then forms a mixed liquid (hereinafter also referred to as polyol-barium sulfate mixed liquid) of the liquid polyol and the powdery barium sulfate.

The polyol system portion 100a includes a tank 120a and a high-pressure pump 120b. The tank 120a is supplied with the polyol-barium sulfate mixed liquid from the stirring device 110c through piping P3 and stores the polyol-barium sulfate mixed liquid. In the present embodiment, the tank 120a is constructed by an air containing tank, and the tank 120a suppresses pulsation of the polyol-barium sulfate mixed liquid supplied from the stirring device 110c by air pressure and stores the mixed liquid as a stable polyol-barium sulfate mixed liquid.

The high-pressure pump 120b sucks in the polyol-barium sulfate mixed liquid from the tank 120a through piping P4 according its operation, thereby to elevate pressure of the polyol-barium sulfate mixed liquid. Then, the high-pressure pump 120b discharges the polyol-barium sulfate mixed liquid as a high-pressure polyol-barium sulfate mixed liquid to an atomizer or sprayer 150 (described later) through a hose P5.

Meanwhile, the isocyanate system portion 100b includes an isocyanate supply source 130a, a filler supply source 130b, and a stirring device 130c. The isocyanate supply source 130a stores liquid isocyanate, and the isocyanate supply source 130a is capable of supplying the stirring device 130c with the liquid isocyanate.

Herein, a supply amount of the liquid isocyanate to the stirring device 130c is adjustable in the isocyanate supply source 130a. In addition, adjustment of the supply amount of the isocyanate in the isocyanate supply source 130a is conducted, for example, with a mechanism (for example, opening adjustment valve) for adjusting an opening degree of the supply port portion (not shown) of the isocyanate supply source 130a to the stirring device 130c.

The filler supply source 130b stores powdery barium sulfate of a kind of filler, and the filler supply source 130b is capable of supplying the stirring device 130c with powdery barium sulfate. Herein, a supply amount of the powdery barium sulfate to the stirring device 130c is adjustable in the filler supply source 130b. In addition, adjustment of the supply amount of the barium sulfate in the filler supply source 130b is conducted, for example, with a mechanism (for example, opening adjustment valve) for adjusting an opening degree of the supply port portion (not shown) of the filler supply source 130b to the stirring device 130c.

The stirring device 130c is supplied with the liquid isocyanate from the isocyanate supply source 130a through its supply port portion and piping Q1 and also supplied with powdery barium sulfate from the filler supply source 130b through the supply port portion and piping Q2 according to its operation. Then, the stirring device 130c stirs these liquid isocyanate and powdery barium sulfate so as to mix mutually and uniformly and forms to form a mixed liquid of the liquid isocyanate and the powdery barium sulfate (hereinafter also referred to as a isocyanate-barium sulfate mixed liquid).

The isocyanate system portion 100b includes a tank 140a and a high-pressure pump 140b. The tank 140a is supplied with the isocyanate-barium sulfate mixed liquid from the stirring device 130c through piping Q3 and stores the isocyanate-barium sulfate mixed liquid. In the present embodiment, the tank 140a is constructed by an air containing tank likewise the tank 120a, and the tank 140a suppresses pulsation of the isocyanate-barium sulfate mixed liquid supplied from the stirring device 130c by air pressure and stores the mixed liquid as a stable isocyanate-barium sulfate mixed liquid.

The high-pressure pump 140b sucks in the isocyanate-barium sulfate mixed liquid from the tank 140a through piping Q4 in its operation and elevates pressure of the isocyanate-barium sulfate mixed liquid. Then, the high-pressure pump 140b discharges the isocyanate-barium sulfate mixed liquid as a high-pressure isocyanate-barium sulfate mixed liquid to the sprayer 150 through a hose Q5. Additionally, the high-pressure isocyanate-barium sulfate mixed liquid is a high pressure mixed liquid such that atomization by the sprayer is well done, together with the above-described high-pressure polyol-barium sulfate mixed liquid.

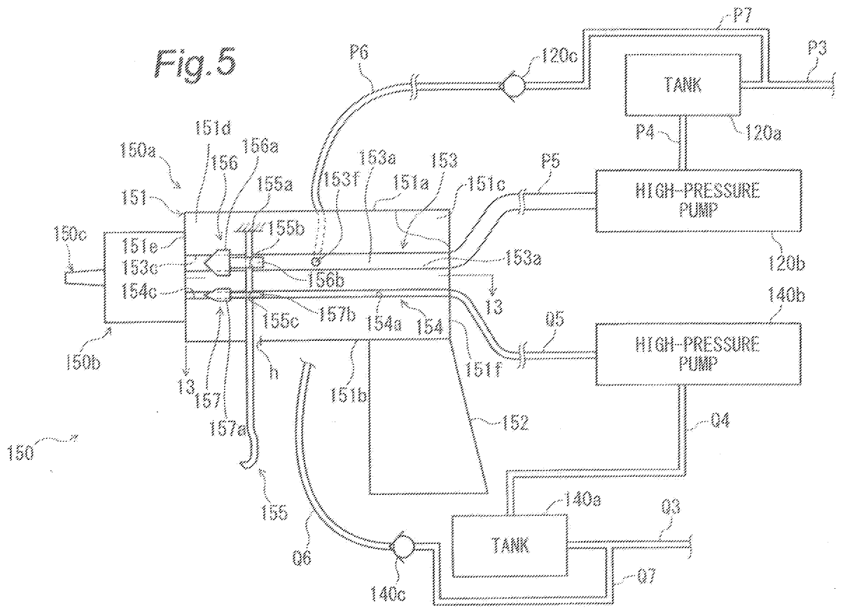

The sprayer 150 is constructed by a spray gun of mixing type, and the sprayer 150 includes a gun main body 150a, a mixer 150b and a nozzle 150c, as shown in any one of FIG. 5 to FIG. 7. Hereinafter, in the present embodiment, the sprayer 150 is also referred to as a spray gun 150. In addition, the sprayer 150 is not limited to the spray gun 150, but may be any sprayer having a function similar to that of the spray gun 150.

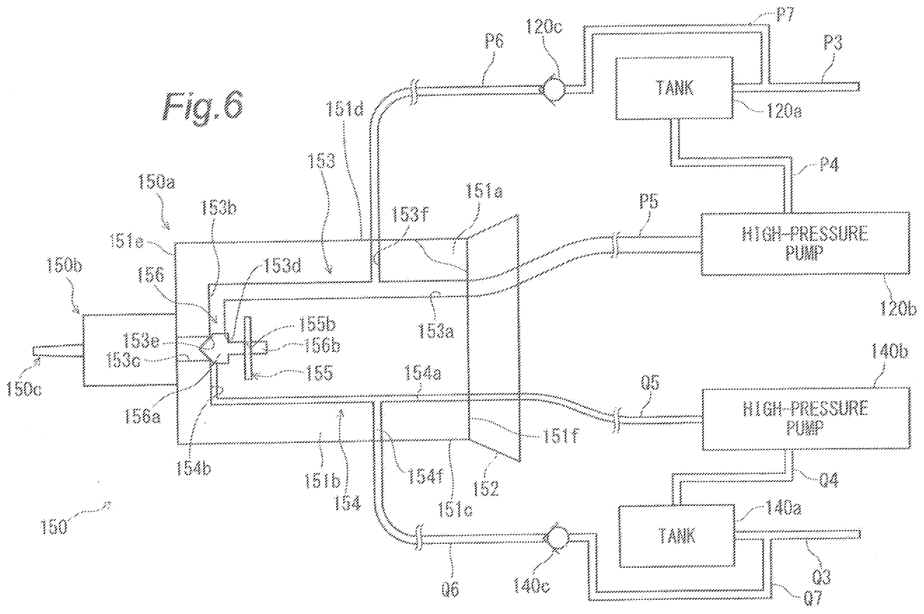

In the sprayer 150, the gun main body 150a includes a casing 151 and a handle 152, as shown in FIG. 5 and FIG. 6. The casing 151 is formed into a rectangular parallelepiped form by upper and lower walls 151a, 151b, left and right walls 151c, 151d and front and rear walls 151e, 151f. The handle 152 is extended downward from a rear portion of the lower wall 151b of the casing 151.

As can be seen from FIG. 5 to FIG. 7, the gun main body 150a also includes an upper passage 153 and a lower passage 154. These upper passage 153 and lower passage 154 are disposed in the casing 151 from the rear wall 151f to the front wall 151e.

The upper passage 153 has a base end passage portion 153a, a middle passage portion 153b and a tip passage portion 153c. As can be seen from FIG. 5 and FIG. 6, the base end passage portion 153a is extended from the rear wall 151f toward the front wall 151e of the casing 151 parallel with the right wall 151d at an upper right side than the center axis of the casing 151. The base end passage portion 153a is situated at its extending end opening portion in the front interior of the casing 151.

Also, the base end opening portion of the base end passage portion 153a is communicated through the rear wall 151f of the casing 151 to an extending end opening portion of a hose P5 which extends from the high-pressure pump 120b. Accordingly, the high-pressure pump 120b pumps the high-pressure polyol-barium sulfate mixed liquid into the base end passage portion 153a of the upper passage 153 through the hose P5.

As shown in FIG. 6, the middle passage portion 153b is bent and extended in an L-shape from the extending end opening portion of the base end passage portion 153a toward the left wall 151c of the casing 151. Accordingly, the high-pressure polyol-barium sulfate mixed liquid pumped into the base end passage portion 153a is further pumped into the middle passage portion 153b from the extending end opening portion of the base end passage portion 153a. In addition, the middle passage portion 153b is situated at its extending end opening portion directly above the center axis of the casing 151.

As shown in FIG. 6, the tip end passage portion 153c is bent and extended in an L-shape from the extending end opening portion of the middle passage portion 153b toward the front wall 151e of the casing 151. Accordingly, the tip end passage portion 153c is communicated at its extending end opening portion to a rear opening portion of the mixer 150b directly above the center axis of the casing 151. Thus, the high-pressure polyol-barium sulfate mixed liquid pumped into the middle passage portion 153b is further pumped into the mixer 150b through the rear opening portion thereof through the tip end passage portion 153c.

In the present embodiment, the high-pressure polyol-barium sulfate mixed liquid pumped into the base end passage portion 153a of the upper passage 153 is designed to return into a piping P3 through a branched passage portion153f, a hose P6, a check valve 120c and piping P7 as shown in either of FIG. 4 and FIG. 6, when an upper valve part is closed as described later. This is to suppress waste of the high-pressure polyol-barium sulfate mixed liquid under a non-atomizing operating condition of the sprayer 150.

Herein, the branched passage portion 153f is branched from an intermediate portion of the base end passage portion 153a and connected communicably to the piping P7 through the right wall 151d of the casing 151, the hose P6 and the check valve 120c. In addition, the check valve 120c allows flow of the high-pressure polyol-barium sulfate mixed liquid from the hose P6 to the piping P7, and blocks flow of the high-pressure polyol-barium sulfate mixed liquid from the piping P7 to the hose P6.

The lower passage 154 includes a base end passage portion 154a, a middle passage portion 154b and a tip end passage portion 154c, as shown in any one of FIG. 5 to FIG. 7. As can be seen from FIG. 5 and FIG. 6, the base end passage portion 154a is extended from the rear wall 151f toward the front wall 151e of the casing 151 parallel with the left wall 151c at the upper left side than the center axis of the casing 151. The base end passage portion 154a is situated at its extending end opening portion in the front interior of the casing 151.

Also, the base end passage portion 154a passes through the rear wall 151f of the casing 151 at its base end opening portion, and communicates with the extending end opening portion of the hose Q5 extending from the high-pressure pump 140b. Accordingly, the high-pressure pump 140b pumps the high-pressure isocyanate-barium sulfate mixed liquid into the base end passage portion 154a of the lower passage 154 through the hose Q5.

The middle passage portion 154b is bent and extended in an L-shape from the extending end opening portion of the base end passage portion 154a toward the right wall 151d of the casing 151. And, the middle passage portion 154b is situated at its extending end opening portion directly below the extending end opening portion of the middle passage portion 153b of the upper passage 153. Herein, the high-pressure isocyanate-barium sulfate mixed liquid pumped into the base end passage portion 154a is further pumped into the middle passage portion 154b from the base end passage portion 154a through its extending end opening portion.

The tip end passage portion 154c is situated directly below the tip end passage portion 153c of the upper passage 153, and is bent and extended from the extending end opening portion of the middle passage portion 154b toward the front wall 151e of the casing 151 in an L-shape. Accordingly, the tip end passage portion 154c communicates at its extending end opening with the rear opening portion of the mixer 150b directly below the tip end passage portion 153c of the right passage 153.

Thus, the high-pressure isocyanate-barium sulfate mixed liquid pumped into the middle passage portion 154b is further pumped into the mixer 150b through the tip end passage portion 154c and the rear opening portion of the mixer 150b.

In the present embodiment, the high-pressure isocyanate-barium sulfate mixed liquid pumped into the base end passage portion 154a of the lower passage 154 is designed to return into the piping Q3 through a branched passage portion 154f, a hose Q6, a check valve 140c and piping Q7, when a lower valve part is closed as described later. This is to suppress waste of the high-pressure isocyanate-barium sulfate mixed liquid under a non-atomizing condition of the sprayer 150.

Herein, the branched passage portion 154f is branched from an intermediate portion of the base end passage portion 154a and is connected communicably to the piping Q7 through the left wall 151c of the casing 151, the hose Q6 and the check valve 140c. In addition, the check valve 140c allows flow of the high-pressure isocyanate-barium sulfate mixed liquid from the hose Q6 to the piping Q7, and inhibits flow of the high-pressure isocyanate-barium sulfate mixed liquid from the piping P7 to the hose P6.

The gun main body 150a includes a belt-shaped lever 155, an upper valve body 156, and a lower valve body 157, as shown in any one of FIG. 5 to FIG. 7. The belt-shaped lever 155 is supported at its base end portion 155a rotatably in a fore-and-aft direction by a left-right directional center-front portion of the upper wall 151a of the casing 151. And, the belt-shaped lever 155 is extended downward from the base end portion 155a tiltably in the fore-and-aft direction, and is further extended downward through a through-hole portion h (see FIG. 5) formed in the lower wall 151b.

Accordingly, the lever 155 tilts rearward against a spring (not shown) with the base end portion 155a as a fulcrum or supporting point by hooking a finger of a hand holding the handle 152 on an extending portion of the lever 155 and pulling the lever 155 by the hand rearward. On the other hand, the lever 155 tilts frontward under a elastic restoring force of the spring with the base end portion 155a as the supporting point.

The upper valve body 156 includes a valve body portion 156a and a shaft portion 156b. The shaft portion 156b is extended coaxially from a rear end portion of the valve body portion 156a so as to pass through a through-hole portion 155b which is formed in an intermediate portion at side of the base end portion 155a of the lever 155. Herein, the shaft portion 156b is connected with an inner circumferential portion of the through-hole portion 155b of the lever 155 inside the through-hole portion 155b in a relatively tiltable manner.

Accordingly, the valve body portion 156a can be seated on an extending base end opening portion of the tip end passage portion 153c through a through-hole portion 153d (see FIG. 6) which is formed in an extending end portion of the middle passage portion 153b of the upper passage 153. In addition, an inner circumferential portion of the through-hole portion 153d of the middle passage portion 153b and an outer circumferential portion of the valve body portion 156a are sealed in a fluid tight manner by a seal(not shown).

Herein, when the lever 155 is in its released state, the upper valve body 156 is pushed at its valve body portion 156a frontward by the lever 155 that is in a frontward tilting condition, and is seated on the extending base end opening portion (hereinafter referred to as an annular valve seat portion 153e) of the tip end passage portion 153c. This means that the upper valve body 156 closes the upper valve portion including the valve body portion 156a and the annular valve seat portion 153e, thereby to block pumping of the high-pressure polyol-barium sulfate mixed liquid from the middle passage portion 153b to the tip end passage portion 153c.

Meanwhile, when the lever 155 tilts rearward as described above, the upper valve body 156 is pulled frontward at the shaft portion 156b, and is separated at the valve body portion 156a from the annular valve seat portion 153d to open the upper valve portion. As a result, it becomes possible to pump the high-pressure polyol-barium sulfate mixed liquid from the middle passage portion 153b to the tip end passage portion 153c.

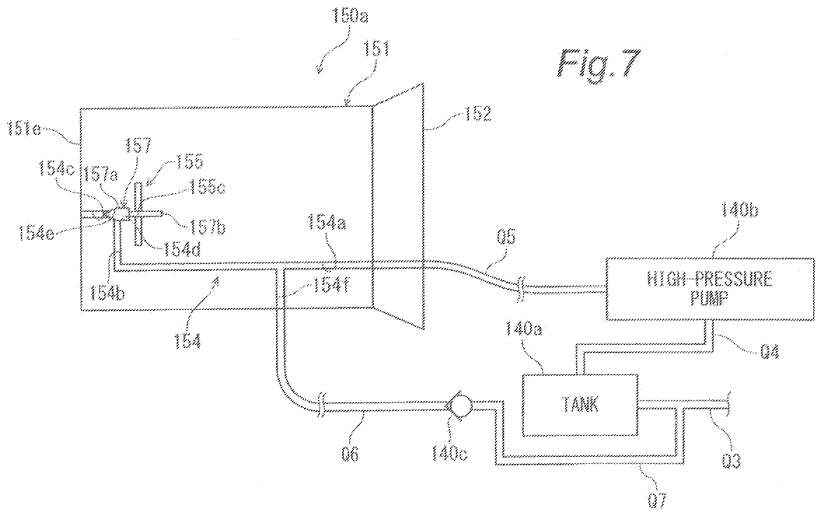

As shown in either of FIG. 5 and FIG. 7, the lower valve body 157 includes a valve body portion 157a and a shaft portion 157b. The shaft portion 157b is extended coaxially from a rear end portion of the valve body portion 157a so as to pass through a through-hole portion 155c (see FIG. 5) which is formed in a lower portion of the through-hole portion 155b of an intermediate portion at the side of the base end portion 155a of the lever 155. Herein, the shaft portion 157b is connected with an inner circumferential portion of the through-hole portion 155c of the lever 155 inside the through-hole portion 155c in a relatively tiltable manner.

Accordingly, the valve body portion 157a can be seated on an extending base end opening portion of the tip end passage portion 154c through a through-hole portion 154d (see FIG. 7) which is formed in an extending end portion of the middle passage portion 154b of the lower passage 154. In addition, an inner circumferential portion of the through-hole portion 154d of the middle passage portion 154b and an outer circumferential portion of the valve body portion 157a are sealed in a fluid tight manner by a seal(not shown).

Herein, when the lever 155 is in its released state, the lower valve body 157 is pushed frontward by the lever 155 that is in a frontward tilting condition, and is seated at the valve body portion 157a on an extending base end opening portion (hereinafter referred to as an annular valve seat portion 154e) of the tip end passage portion 154c. This means that the lower valve body 157 closes the lower valve portion including the valve body portion 157a and the annular valve seat portion 154e, thereby to block pumping of the high-pressure isocyanate-barium sulfate mixed liquid from the middle passage portion 154b to the tip end passage portion 154c.

Meanwhile, when the lever 155 tilts rearward as described above, the lower valve body 157 is pulled at the shaft portion 157b frontward, and is separated at the valve body portion 157a from the annular valve seat portion 154e to open the above-mentioned lower valve portion. As a result, it becomes possible to pump the high-pressure isocyanate-barium sulfate mixed liquid from the middle passage portion 154b to the tip end passage portion 154c.

In the present embodiment, each of the hoses P5, P6, Q5 and Q6 has a sufficiently long full length so as to enhance the degree of freedom of carrying of the sprayer 150.

The mixer 150b is assembled at its rear portion to the center portion of the front wall 151e of the casing 151. The mixer 150b is pumped at its rear opening portion with a high-pressure polyol-barium sulfate mixed liquid through the tip end passage portion 153c of the upper passage 153, and is pumped with the high-pressure polyol-barium sulfate mixed liquid through the tip end passage portion 154c of the lower passage 154, thereby to mix the high-pressure polyol-barium sulfate mixed liquid and the high-pressure isocyanate-barium sulfate mixed liquid uniformly.

As the mixer 150b, for example, a static mixer manufactured by Mercury Supply Systems Corporation is employed. In addition, the mixer 150b may be any static mixer without limited to the static mixer of Mercury Supply Systems Corporation, and a dynamic mixer may also be used in place of the static mixer, as long as the mixer has the function of uniformly mixing the high-pressure polyol-barium sulfate mixed liquid and the high-pressure isocyanate-barium sulfate mixed liquid.

The nozzle 150c is connected to the mixer 150b so as to extend frontward from the front end center portion of the mixer 150b. The nozzle 150c is designed to spray in the form of spray or mist the high-pressure polyol-barium sulfate mixed liquid and the high-pressure isocyanate-barium sulfate mixed liquid which are mixed uniformly by and discharged from the mixer 150b as a raw material for urethane resin.

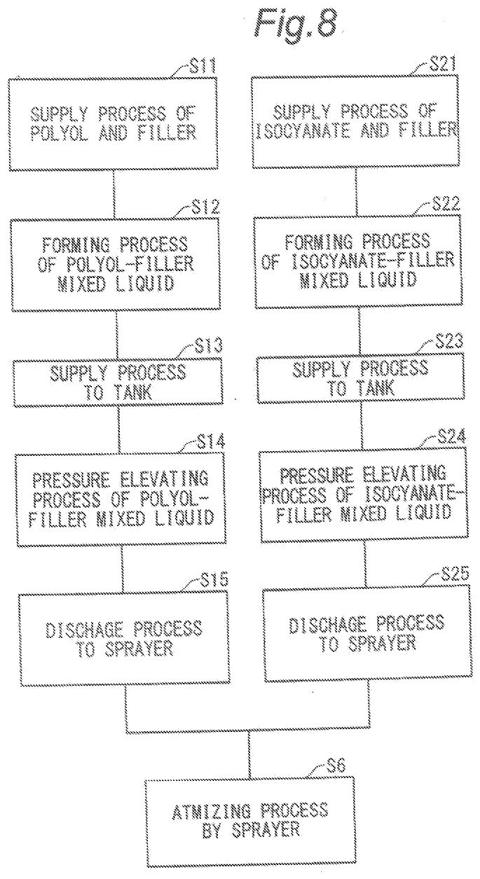

Next, a forming method of a sound insulating layer is described by referring to FIG. 4 to FIG. 8. At a supply process S11 of polyol and filler supply process in FIG. 8, a polyol is supplied from the polyol supply source 110a to the stirring device 110c through the piping P1, and barium sulfate is supplied from the filler supply source 110b to the stirring device 110c through the piping P2.

Herein, the mixing amount of barium sulfate to polyol is set to be a mixing amount of 60 (wt %) within a first predetermined mixing amount range. Accordingly, the mixing amount of liquid polyol is 40 (wt %). In the present embodiment, the first predetermined mixing amount range is 10 (wt %) to 70 (wt %), more preferably 40 (wt %) to 60 (wt %).

The reason why the lower limit of the mixing amount of barium sulfate to polyol is selected to 10 (wt %) is based on the fact that if the mixing amount is less than 10 (wt %), a specific gravity as barium sulfate cannot be secured. Meanwhile, the reason why the upper limit of the mixing amount of barium sulfate to polyol is selected to 70 (wt %) is based on the fact that if the mixing amount is more than 70 (wt %), a ratio of barium sulfate to polyol is excessive and the viscosity is too high.

Then, at a forming process S12 of polyol-filler mixed liquid, polyol from the polyol supply source 110a and barium sulfate as a filler from the filler supply source 110b are stirred and mixed uniformly by the stirring device 110c to be formed as a polyol-barium sulfate mixed liquid. In association therewith, at the next supply process S13 to tank, the polyol-barium sulfate mixed liquid is supplied to the tank 120a from the stirring device 110c through the piping P3 and stored in the tank 120a.

Thereafter, at a pressure elevating process S14 of polyol-filler mixed liquid, the polyol-barium sulfate mixed liquid stored in the tank 120a as described above is sucked by the high-pressure pump 120b through the piping P4, and is elevated at pressure as a high-pressure polyol-barium sulfate mixed liquid.

After such pressure elevation, at the next discharge process S15 to sprayer, the high-pressure polyol-barium sulfate mixed liquid is discharged to the sprayer 150 by the high-pressure pump 120b through the hose P5.

Meanwhile, at supply process S21 of isocyanate and filler in FIG. 8, isocyanate is supplied from the isocyanate supply source 130a to the stirring device 130c through the piping Q1, and barium sulfate is supplied from the filler supply source 130b to the stirring device 130c through the piping Q2.

Herein, although the isocyanate is different in mass from the polyol, the mixing amount of barium sulfate to isocyanate is set to be a mixing amount of 60 (wt %) within a second predetermined mixing amount range. Accordingly, the mixing amount of liquid isocyanate is 40 (wt %). In the present embodiment, the second predetermined mixing amount range is 10 (wt %) to 70 (wt %), more preferably 40 (wt %) to 60 (wt %), similarly to the first predetermined mixing amount range,

The reason why the lower limit of the mixing amount of barium sulfate to isocyanate is selected to 10 (wt %) is based on the fact that if the mixing amount is less than 10 (wt %), a specific gravity as barium sulfate cannot be secured. Meanwhile, the reason why the upper limit of the mixing amount of barium sulfate to isocyanate is selected to 70 (wt %) is based on the fact that if the mixing amount is more than 70 (wt %), a ratio of barium sulfate is excessive and the viscosity is too high.

Then, at a forming process S22 of isocyanate-filler mixed liquid, isocyanate from the isocyanate supply source 130a and barium sulfate from the filler supply source 130b are stirred and mixed uniformly by the stirring device 130c to be formed as an isocyanate-barium sulfate mixed liquid. In association therewith, at the next supply process S23 to tank, the isocyanate-barium sulfate mixed liquid is supplied to the tank 140a from the stirring device 130c through the piping Q3 and stored in the tank 140a.

The isocyanate-barium sulfate mixed liquid stored in the tank 140a in this way is sucked by the high-pressure pump 140b through the piping Q4, and is elevated in its pressure at a pressure elevation process S24 of isocyanate-barium sulfate mixed liquid. The isocyanate-barium sulfate mixed liquid thus having elevated pressure is discharged to the sprayer 150 through the hose Q5 by the high-pressure pump 140b as a high-pressure isocyanate-barium sulfate mixed liquid at a discharge process S25 to sprayer.

When the processes of the discharge processes S15, S25 by the respective high-pressure pumps are performed as described above, the high-pressure polyol-barium sulfate mixed liquid discharged from the high-pressure pump 120b to the sprayer 150 as described above is pumped into the base end passage portion 153a of the upper passage 153 of the gun main body 150a. Meanwhile, the high-pressure isocyanate-barium sulfate mixed liquid discharged to the sprayer 150 from the high-pressure pump 140b as described above is pumped into the base end passage portion 154a of the lower passage 154 of the gun main body 150a.

At this stage, both the upper valve portion and the lower valve portion of the gun main body 150a are closed. Accordingly, the high-pressure polyol-barium sulfate mixed liquid pumped into the base end passage portion 153a returns to the piping P3 through the branched passage portion 153f, the hose P6, the check valve 120c and the piping P7. Meanwhile, the high-pressure isocyanate-barium sulfate mixed liquid pumped into the base end passage portion 154a returns to the piping Q3 through the branched passage portion 154f, the hose Q6, the check valve 140c and the piping Q7. Thus, preparation required for application by atomizing of the sprayer 150 is ready.

In such a condition, the process of the next atomizing process S6 by a sprayer is conducted. First, an operator grips the handle 152 of the sprayer 150 with one hand. Then, the operator maintains the sprayer 150 so that the nozzle 150c is opposed to the sound absorbing layer 50 that is the application member M.

Thereafter, as the operator hooks a finger of the one hand on the lever 155 of the sprayer 150 and pulls the lever 155, the lever 155 tilts rearward with the base end portion 155a as the supporting point. According to such rearward tilting of the lever 155, the upper valve body 156 is moved rearward, and is separated at the valve body portion 156a from the annular valve seat portion 153e to open the upper valve portion, and the lower valve body 157 is moved rearward and is separated at the valve body portion 157a from the annular valve seat portion 154e to open the lower valve portion.

When both the upper valve portion and the lower valve portion are opened in this way, the high-pressure polyol-barium sulfate mixed liquid in the base end passage portion 153a of the upper passage 153 is pumped at its rear opening portion into the mixer 150c through the middle passage portion 153b, the annular valve seat part 153e and the tip end passage portion 153e, and the high-pressure isocyanate-barium sulfate mixed liquid in the base end passage portion 154a of the lower passage 154 is pumped at its rear opening portion into the mixer 150c through the middle passage portion 154b, the annular valve seat portion 154e and the tip end passage portion 153e.

Thus, the high-pressure polyol-barium sulfate mixed liquid and the high-pressure isocyanate-barium sulfate mixed liquid are mixed uniformly by the mixer 150b in its interior, and atomized as a mixed liquid for atomization on the rear surface of the sound absorbing layer 50 that is the application member M from the nozzle 150c. Herein, the operator moves the sprayer 150 so as to atomize the mixed liquid for atomization in a predetermined thickness over the entire surface of the sound absorbing layer 50. In this manner, the mixed liquid for atomization is applied by atomization over the entire rear surface of the sound absorbing layer 50.

Accordingly, a layer formed of the applied mixed liquid for atomization is hardened, thereby to be adhesively formed on the sound absorbing layer 50 as the sound insulating layer 60.

As described above, the sound insulating layer 60 is adhesively formed along the sound absorbing layer 50 by the application as described above, thereby to complete formation of the dash silencer DS.

When the engine E generates engine sounds in association with its operation in the motor vehicle after completing formation of the dash silencer DS, as previously described, the engine sounds enter the dash silencer DS through the dash panel 30 as noises. Then, the noises are absorbed by the sound absorbing layer 50 and thereafter enters the sound insulating layer 60. Accordingly, the noises from the sound absorbing layer 50 are insulated by the sound insulating layer 60.

As described above, in the present embodiment, in formation of the sound insulating layer 60, a polyol-barium sulfate mixed liquid and an isocyanate-barium sulfate mixed liquid are separately prepared as raw materials for urethane resin. The polyol-barium sulfate mixed liquid and the isocyanate-barium sulfate mixed liquid are then pumped to the sprayer 150 as a high-pressure polyol-barium sulfate mixed liquid and a high-pressure isocyanate-barium sulfate mixed liquid.

Subsequently, the high-pressure polyol-barium sulfate mixed liquid and the high-pressure isocyanate-barium sulfate mixed liquid are uniformly mixed and atomized by the sprayer 150 to the sound absorbing layer 50 that is the application member M, thereby to be adhesively formed on the sound absorbing layer 50 as the sound insulating layer 60. Accordingly, the sound insulating layer 60 can be laminated on the sound absorbing layer 50 simultaneously with formation of the sound insulating layer 60.

Herein, as described above, the mixing amounts of the liquid polyol and the powdery barium sulfate in the polyol-barium sulfate mixed liquid are 40 (wt %) and 60 (wt %), respectively, and similarly, the mixing amounts of the liquid isocyanate and the powdery barium sulfate in the isocyanate-barium sulfate mixed liquid are 40 (wt %) and 60 (wt %), respectively. Therefore, the weights of the polyol-barium sulfate mixed liquid and the isocyanate-barium sulfate mixed liquid are properly ensured.

When the high-pressure polyol-barium sulfate mixed liquid and the high-pressure isocyanate-barium sulfate mixed liquid are mixed and atomized by the sprayer 150 to the sound absorbing layer 50, the mixture liquid of the polyol-barium sulfate mixed liquid and the isocyanate-barium sulfate mixed liquid is hardened under the hardening or curing action of isocyanate as a hardening or curing agent to become proper urethane resin, thereby to be adhesively formed on the sound absorbing layer 50 as the sound shielding layer 60. This means that the sound insulating layer 60 is laminated on the sound absorbing layer 50 simultaneously with formation of the sound insulating layer 60. Therefore, the working efficiency for formation of the dash silencer DS can be remarkably improved.

Herein, a mixture liquid prepared by previously mixing the high-pressure polyol-barium sulfate mixed liquid and the high-pressure isocyanate-barium sulfate mixed liquid is not pumped to the sprayer 150, but the high-pressure polyol-barium sulfate mixed liquid and the high-pressure isocyanate-barium sulfate mixed liquid are pumped separately to the sprayer 150 and atomized by the sprayer 150 itself while being mixed in the sprayer 150 itself. Thus, mixing of the high-pressure polyol-barium sulfate mixed liquid and the high-pressure isocyanate-barium sulfate mixed liquid and atomization of the liquid under the above-mentioned mixing are conducted by the sprayer 150 consecutively without leaving time for each other.

Accordingly, the mixture liquid of the high-pressure polyol-barium sulfate mixed liquid and the high-pressure isocyanate-barium sulfate mixed liquid can maintain excellent fluidity without hardening, until the application by atomization to the sound absorbing layer 50 is completed. This means that the application by the above-mentioned atomization can be successfully conducted, and formation or generation of the urethane resin forming the sound insulating layer 60 can be properly achieved.

Also, the mixture liquid of the high-pressure polyol-barium sulfate mixed liquid and the high-pressure isocyanate-barium sulfate mixed liquid is atomized by the sprayer 150. Thus, troublesome steps of manually laminating the sound insulating layer 60 on the sound absorbing layer 50 is not involved.

Furthermore, application by atomization of the sprayer 150 is conducted in such a way. Thus, the sound insulating layer 50 can be formed successfully even if it is thin.

In practice of the present invention, the following various modifications can be recited without limited to the foregoing embodiment.

(1) In practice of the present invention, in place of the high-pressure pump 120b or 140b described in the above embodiment, for example, a hydraulic cylinder may be employed, and the pressure of the polyol-barium sulfate mixed liquid from the tank 120a or the isocyanate-barium sulfate mixed liquid from the tank 140a may be elevated by the hydraulic cylinder, and the high-pressure polyol-barium sulfate mixed liquid or the high-pressure isocyanate-barium sulfate mixed liquid may be discharged to the atomizer 150.

(2) In practice of the present invention, the mixing amount of barium sulfate to polyol and the mixing amount of barium sulfate to isocyanate do not have to be the same as described in the above embodiment. For example, the mixing amount of barium sulfate to polyol may be increased and the mixing amount of barium sulfate to isocyanate may be decreased, the mixing amounts may be reversed, or one of the mixing amounts may be doubled and the other of the mixing amounts may be zero. In brief, the above-described mixing amounts may be varied at will as long as the total amount of barium sulfate in the polyol-barium sulfate mixed liquid and in the isocyanate-barium sulfate mixed liquid is the predetermined amount, and the polyol-barium sulfate mixed liquid or the isocyanate-barium sulfate mixed liquid to the atomizer 150 from the high-pressure pumps 120b and 140b can keep proper fluidity.

(3) In practice of the present invention, the filler may be calcium carbonate in place of barium sulfate. The filler mixed in the liquid polyol may be barium sulfate, and the filler mixed in the liquid isocyanate may be calcium carbonate.

(4) In practice of the present invention, the respective stirring devices 110c, 130c may be omitted by separately preparing the polyol-barium sulfate mixed liquid and the isocyanate-barium sulfate mixed liquid as described in the above embodiment as materials for urethane resin, and storing the materials in the respective tanks 120a, 140a, and pumping the polyol-barium sulfate mixed liquid in the tank 120a and the isocyanate-barium sulfate mixed liquid in the tank 140a to the atomizer 150 while elevating pressure by the high-pressure pumps 120b, 140b, respectively.

(5) In practice of the present invention, an application process of applying a mixed liquid for atomization prepared by mixing a polyol, an isocyanate and barium sulfate in a layer form by a sprayer along a surface of the sound absorbing layer may be provided, and in the application process, the mixed liquid for atomization may be adhesively formed on the surface of the sound absorbing layer as a sound insulating layer formed of a urethane resin in accordance with hardening or curing in the application caused by atomization.

(6) In practice of the present invention, the material for forming the sound absorbing layer 40 as described in the above embodiment is not limited to felt described in the above embodiment, but may be a structural material such as organic fibers such as PET and wool, inorganic fibers such as glass wool, or may be a porous synthetic resin material such as urethane foam.

(7) In practice of the present invention, the present invention may be applied to various motor vehicle silencers or other sound insulators without limited to the dash silencer.

1. A soundproof body provided with a sound insulating layer comprising a porous layer, and a sound insulating layer laminated on the porous layer,
wherein the sound insulating layer is formed with urethane resin so as to have a basis weight within a predetermined low basis weight range, the sound insulating layer being laminated on the porous layer.

2. The soundproof body provided with a sound insulating layer according to claim 1,
wherein the predetermined low basis weight range is a range of 200 (g/m²) to 2000 (g/m²).

3. The soundproof body provided with a sound insulating layer according to claim 1, which is a soundproof body for a motor vehicle mounted on a body panel of the motor vehicle.

4. A manufacturing method of a sound insulating layer in a soundproof body by application of raw materials for urethane resin, which comprises:
an applying process of atomizing a mixed liquid formed by mixing polyol, isocyanate and filler as a mixed liquid for atomization along a surface of a porous layer of the soundproof body by a sprayer to apply the atomized mixed liquid in a layer-like fashion on the surface of the porous layer,
wherein at the applying process, the mixed liquid for atomization is adhesively formed on the surface of the porous layer as a sound insulating layer of urethane resin in accordance with hardening of the mixed liquid for atomization caused by its applying.

5. The manufacturing method of a sound insulating layer in a soundproof body by application of raw materials for urethane resin according to claim 4,
wherein application of the mixed liquid as the mixed liquid for atomization is performed so that a basis weight of the sound insulating layer becomes a value within the predetermined low basis weight range.

6. A manufacturing method of a sound insulating layer in a soundproof body by application of raw materials for urethane resin, which comprises:
an applying process in which a first mixed liquid of polyol and filler and a second mixed liquid of isocyanate and filler, which are prepared separately as a raw material for urethane resin, are mixed as a mixed liquid for atomization and atomized by a sprayer along a surface of a porous layer of the soundproof body to apply the mixed liquid for atomization in a layer-like fashion along the surface of the porous layer,
at the applying process, the mixed liquid for atomization is adhesively formed on the surface of the porous layer as a sound insulating layer of urethane resin in accordance with hardening of the mixed liquid for atomization caused by its applying.

7. The manufacturing method of a sound insulating layer in a soundproof body by application of raw materials for urethane resin according to claim 6,
wherein application of the first and second mixed liquids as the mixed liquid for atomization is performed so that a basis weight of the sound insulating layer becomes a value within the predetermined low basis weight range.

8. The manufacturing method of a sound insulating layer in a soundproof body by application of raw materials for urethane resin according to claim 6, which comprises:
a first mixing process of mixing powdery filler into liquid polyol to form the first mixed liquid,
a second mixing process of mixing powdery filler into liquid isocyanate to form the second mixed liquid,
a first pressure elevating process of elevating pressure of the first mixed liquid formed at the first mixing process to forming a first high-pressure mixed liquid, and
a second pressure elevating process of elevating pressure of the second mixed liquid to form a second high-pressure mixed liquid,
at the applying process, the first high-pressure mixed liquid formed at the first pressure elevating process and the second high-pressure mixed liquid formed at the second pressure elevating process are mixed as the mixed liquid for atomization and atomized by the sprayer along the surface of the porous layer of the soundproof body to apply the mixed liquid for atomization along the surface of the porous layer in a layer-like fashion, the mixed liquid for atomization being adhesively formed on the surface of the porous layer as a sound insulating layer of urethane resin in accordance with hardening of the mixed liquid for atomization caused by its applying.

9. The manufacturing method of a sound insulating layer in a soundproof body by application of raw materials for urethane resin according to claim 8,
wherein application of the first and second high-pressure mixed liquids as the mixed liquid for atomization is performed so that a basis weight of the sound insulating layer becomes a value within the predetermined low basis weight range.

10. The manufacturing method of a sound insulating layer in a soundproof body by application of raw materials for urethane resin according to claim 5, wherein the predetermined low basis weight range is a range of 200 (g/m²) to 2000 (g/m²).

11. The manufacturing method of a sound insulating layer in a soundproof body by application of raw materials for urethane resin according to claim 6,
wherein a mixing amount of the filler in the first mixed liquid is a value within a range of 10 (wt %) to 70 (wt %), and a mixing amount of the filler in the second mixed liquid is a value within a range of 10 (wt %) to 70 (wt %), and a volume ratio of the first mixed liquid to the second mixed liquid is a value within a predetermined volume ratio range of 2 to 5.

12. The soundproof body provided with a sound insulating layer according to claim 2, which is a soundproof body for a motor vehicle mounted on a body panel of the motor vehicle.

13. The manufacturing method of a sound insulating layer in a soundproof body by application of raw materials for urethane resin according to claim 7,
wherein the predetermined low basis weight range is a range of 200 (g/m²) to 2000 (g/m²).

14. The manufacturing method of a sound insulating layer in a soundproof body by application of raw materials for urethane resin according to claim 9,
wherein the predetermined low basis weight range is a range of 200 (g/m²) to 2000 (g/m²).

15. The manufacturing method of a sound insulating layer in a soundproof body by application of raw materials for urethane resin according to claim 8,
wherein a mixing amount of the filler in the first mixed liquid is a value within a range of 10 (wt %) to 70 (wt %), and a mixing amount of the filler in the second mixed liquid is a value within a range of 10 (wt %) to 70 (wt %), and
a volume ratio of the first mixed liquid to the second mixed liquid is a value within a predetermined volume ratio range of 2 to 5.
